(19) United States
(12) Patent Application Publication
(10) Pub. No.: US 2012/0000564 A1
(43) Pub. Date: Jan. 5, 2012

(54) FLEXIBLE TUBING

(76) Inventor: Dino L. Tsapatsaris, Wykoff, NJ (US)

(21) Appl. No.: 12/829,810

(22) Filed: Jul. 2, 2010

(51) Int. Cl. F16L 9/22; B23P 19/04

(52) U.S. Cl. 138/155; 29/428

(57) ABSTRACT

An apparatus for conveying fluids is provided which includes a plurality of segments, such as preferably ceramic segments, including a first segment and a last segment and an inner lining. Each of the plurality of segments may have a central opening, a periphery surrounding the central opening, a substantially concave top surface surrounding the central opening, and a substantially convex bottom surface surrounding the central opening. The plurality of segments may be configured so that the substantially convex bottom surface of each segment of the plurality of segments, except for the last segment, sits on the substantially concave top surface of an adjacent segment of the plurality of segments. The plurality of segments are configured so that fluids can pass through the central openings of the plurality of segments. The inner lining surrounds the periphery of each of the plurality of segments.

### FIELD OF THE INVENTION

This invention relates to improved methods and apparatus for reducing erosion and wear in flexible tubing and hoses.

### BACKGROUND OF THE INVENTION

There are various devices known in the prior art for flexible tubing. For example, there are flexible tubes used to isolate vibration in piping systems, and there are flexible tubes used to convey fluids between two moving components. Should a fluid that is erosive or abrasive be used in conventional tubing, it will erode through such conventional tubing quite rapidly.

### SUMMARY OF THE INVENTION

One or more embodiments of the present invention utilize an extremely erosion, abrasion, and wear resistant plurality of segments, such as a plurality of ceramic segments, while still being able to provide the flexibility of ordinary tubing.

In at least one embodiment of the present invention, a method of manufacturing rubber, urethane, or any other flexible hose or tube with a rigid wear-resistant inner core of solid ceramic or ceramic-coated segments is provided.

Solid ceramic or ceramic coated segments are manufactured with one end formed in a concave shape and the other end formed in a convex shape. The segments are assembled axially in the same orientation, and a soft coating, which may include one or more linings is applied to the outside of the assembly to form a completed assembly.

The concave/convex ends of the segments act as ball-and-socket connections, and allow the segments to move in any direction without axial separation.

The ceramic segments, of at least one embodiment of the present invention, prevent the soft, flexible coating from premature failure due to erosion, corrosion, and/or wear caused by the conveyed fluid.

In at least one embodiment of the present invention an apparatus is provided for conveying fluids comprising a plurality of segments, including a first segment and a last segment and an inner lining. Each of the plurality of segments may be substantially the same. Each of the plurality of segments may have a central opening, a periphery surrounding the central opening, a substantially concave top surface surrounding the central opening, and a substantially convex bottom surface surrounding the central opening.

The plurality of segments may be configured so that the substantially convex bottom surface of each segment of the plurality of segments, except for the last segment, sits on the substantially concave top surface of an adjacent segment of the plurality of segments. The plurality of segments are configured so that fluids can pass through the central openings of the plurality of segments. The inner lining surrounds the periphery of each of the plurality of segments.

Each of the plurality of segments may be comprised of ceramic, such as entirely of solid ceramic material. The inner lining may be an elastomer.such as an elastomer selected from the group comprising natural rubber, Buna-N rubber, ethylene propylene, a monomer (M-class) rubber, and a fluoroelastomer. A structural lining may surround the inner lining. The structural lining may be comprised of interwoven threads.

Alternatively, each of the plurality of segments are made of a material which has been coated with wear resistant coating. Each of the plurality of segments may be made of any one of the group of cast iron, ultra-high-molecular-weight polyethylene, and glass-filled PTFE (polytetrafluoroethylene).

The substantially concave top surface and the substantially convex bottom surface of each of the plurality of segments may be aligned with and parallel to each other. Each of the substantially concave top surfaces and each of the substantially convex bottom surfaces may have a radius of curvature of approximately sixty-four and one half degrees.

At least one embodiment of the present application also includes a method comprising configuring a plurality of segments, and applying an inner lining so that it surrounds a periphery of each of the plurality of segments. Each of the plurality of segments may be as previously specified. The method may include forcing first and second end couplings against the first and last segments respectively, applying the inner lining, and then removing the first and second end couplings from the first and last segments. The step of configuring the plurality of segments includes assembling the plurality of segments on a rigid mandrel which has been fixed in place. The method may include applying first and second end connections to the first and last segments, respectively, after removing the first and second end couplings.

### BRIEF DESCRIPTION OF THE DRAWINGS

FIG. 1A shows a top perspective view of segment in for use in accordance with an embodiment of the present invention;

FIG. 1B shows a top view of the segment of FIG. 1A;

FIG. 1C shows a bottom perspective view of the segment of FIG. 1A;

FIG. 1D shows a view of an isometric section of the segment of FIG. 1A taken along a line A-A shown in FIG. 1B;

FIG. 1E shows cross sectional view of the segment of FIG. 1A taken along the line A-A shown in FIG. 1B;

FIG. 2A shows a top perspective view of a plurality of segments stacked on top of each other, each segment, identical to the segment in FIG. 1A;

FIG. 2B shows a bottom perspective view of the plurality of segments shown in FIG. 2A, stacked on top of each other;

FIG. 3 shows a perspective view of a plurality of segments, each identical to the segment in FIG. 1A; with the segments placed together to form a flexible tube;

FIG. 4 shows a perspective view of the plurality of segments of FIG. 3 along with an outer housing used to hold the plurality of segments together, wherein the plurality of segments are shown in a first curved or flexed state;

FIG. 5 shows a top front perspective view of an apparatus in accordance with another embodiment of the present invention;

FIG. 6 shows a cross sectional view of an apparatus in accordance with another embodiment of the present invention; and

FIG. 7 shows a flow chart of a method in accordance with another embodiment of the present invention.

### DETAILED DESCRIPTION OF THE DRAWINGS

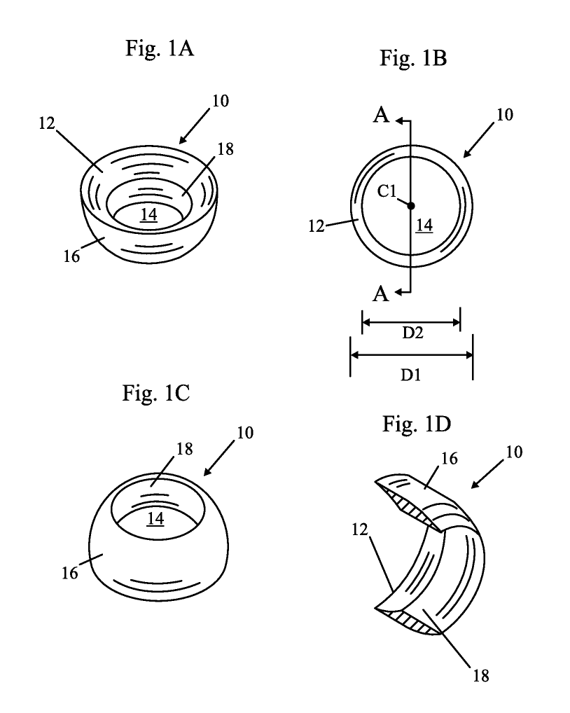

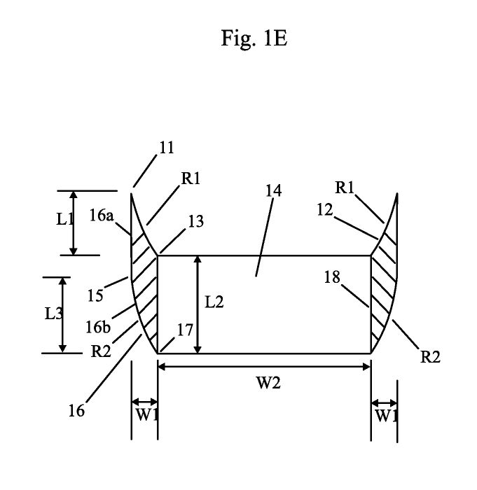

FIG. 1A shows a top perspective view of segment 10 in for use in accordance with an embodiment of the present invention. FIG. 1B shows a top view of the segment 10. FIG. 1C shows a bottom perspective view of the segment 10. FIG. 1D shows a view of an isometric section or portion of the segment 10 of FIG. 1A taken along a line A-A shown in FIG. 1B. FIG. 1E shows cross sectional view of the segment 10 taken along the line A-A shown in FIG. 1B.

The segment 10 may be made entirely of solid ceramic, or any material that has been coated with a wear-resistant coating. Alternatively, the segment 10 may be made of cast iron, ultra-high-molecular-weight polyethylene (UHMWPE or sometimes shortened to UHMW) glass-filled PTFE (polytetrafluoroethylene), or any other type of wear-resistant material. It is preferred that the segment 10 be made entirely of solid ceramic because of its inherently extremely high resistance to erosion, abrasion, and wear.

The segment 10 may have a concave or substantially concave top surface 12 as shown by FIGS. 1A, 1D, and 1E. The top surface 12 may have a radius of curvature, R1, of 1.125 radians which is approximately 64.5 degrees. More or less curvature may be utilized to offer different characteristics (for example to enable more flexibility or conversely to limit the amount of flexibility) The segment 10 may have an outer surface or periphery 16 shown in FIGS. 1C and 1E. The outer surface 16 is comprised of a flat or substantially flat portion 16a and a convex or substantially convex portion or bottom surface 16b shown in FIG. 1E. The outer surface 16, the flat portion 16a, or the bottom surface 16b may be considered to be a periphery. The portion 16b of the outer surface 16 may have a radius of curvature, R2, which will match the radius of the top surface 12 (R1). Having a concave top surface 12 and a convex portion 16b of the bottom surface 16 allows a plurality of segments, each identical to segment 10, or substantially identical to segment 10, to flex as a unit and to function as a ball and socket joint. The top surface 12 radius R1, in at least one embodiment will typically always match the convex portion 16b radius R2, and is preferred to allow a unit of a combination of segments, each identical or substantially identical to segment 10 to nest within each other thereby allowijng for smooth flexing motion without gaps due to mis-matched radii.

The segment 10 may have an inner surface 18 which is flat or substantially flat, as shown in FIG. 1E. The segment 10 may also have a central circular or substantially circular opening 14 shown in FIGS. 1A, 1B, and 1C. The segment 10 may have a length L1, which is typically a function of R1 and may be varied, from a top edge 11 of the top surface 12, to a bottom edge 13 of the top surface 12, as shown in FIG. 1E. There may be a length L2, which may be 0.913 inches as one example, but which may also be varied, from the bottom edge 13 of the top surface 12 to a bottom edge 17 of the bottom surface 16 as shown in FIG. 1E. There may also be a length L3, which may be 0.875 inches, but which may be varied and which is typically is a function of R2, where the flat portion 16a and the curved or convex portion 16b meet, to the bottom edge 17. The distance from the top edge 11 to the middle edge 15, i.e. the length of the portion 16a, may be 0.625 inches, or may be varied to allow for various flexing characteristics.

The segment 10 may have a cross sectional width W1, as shown in FIG. 1E, which may be approximately 0.25 inches in one example, but which may be varied to allow for thinner or thicker cross sectional widths. The opening 14 may have a diameter, W2, which may be about two inches in one example, but which may be varied to accommodate fluid transport systems of various sizes. Thus the outer diameter of the segment 10 may be W2+two times W1. The segment 10 may be a substantially circular disk having a substantially central opening 14, with an inner diameter of (W2) and an outer diameter (W2+two times W1), and with a concave top surface 12 and a convex bottom portion 16b.

The dimensions provided are useful for using the segment 10 and a plurality of identical or substantially identical segments for having fluids flow through the segment 10 and a plurality of identical or substantially identical segments.

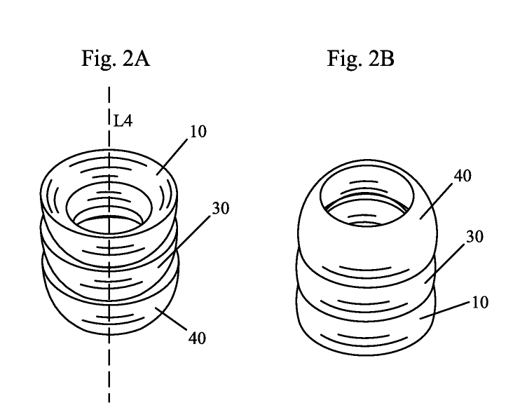

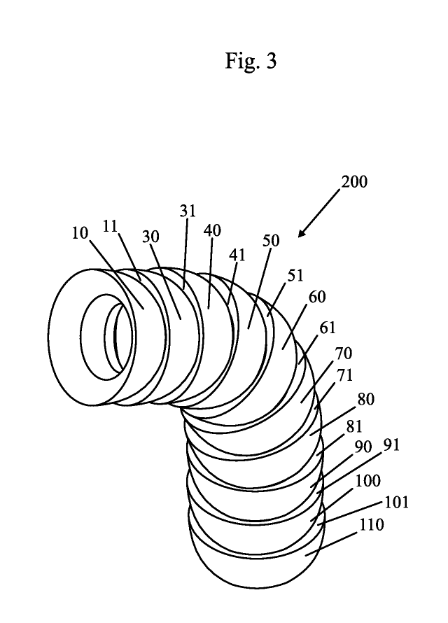

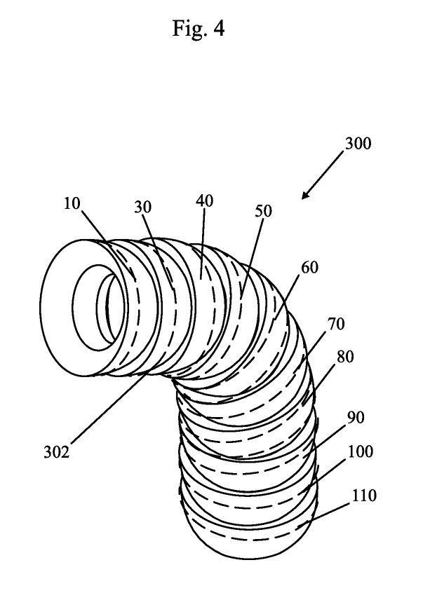

FIG. 2A shows a bottom perspective view of a plurality of segments stacked on top of each other, each segment, identical to the segment 10 in FIG. 1A. FIG. 2A shows segments 10, 30, and 40. The segment 10 is oriented so that its bottom is inserted into the top of the segment 30. The segment 30 is oriented so that its bottom is inserted into the top of the segment 40. The segments 10, 30, and 40 are axially aligned along an axis shown by dashed line L4, passing through the center C1 (shown in FIG. 1B) of opening 14 of segment 10, and the analogous centers of the analogous openings of the segments 30, and 40, not shown. The segments 10, 30 and 40 are aligned in FIG. 2A so that the centers (center C1 of opening 14, and centers of segments 30 and 40 not shown) are aligned, with center C1 being on top of the center of segment 30 and that center being on top of the center for segment 40. The segments 10, 30, and 40 are also oriented in FIG. 2A so that the convex portion 16b of the bottom surface 16 of segment 10 is in contact with and lies on top of the concave top surface of segment 30 (analogous to top surface 12 of segment 10), and the convex portion of the bottom surface of segment 30 (analogous to convex portion 16b of segment 10) is in contact with and lies on of the concave top surface of segment 40 (analogous to top surface 12 of segment 10).

FIG. 2B shows a top perspective view of the plurality of segments, including 10, 30, and 40 stacked on top of each other.

FIG. 3 shows a perspective view of a plurality of segments, including segments 10, 30, 40, 50, 60, 70, 80, 90, 100, and 110, which form a unit 200, wherein each of these segments may be identical to segment 10. In FIG. 3, the bottom of segment 10 has been placed in the top of segment 30 at a junction 11, the bottom of segment 30 has been placed in the top of segment 40 at a junction 31, the bottom of segment 40 has been placed in the top of the segment 50 at a junction 41, the bottom of segment 50 has been placed in the top of segment 60 at a junction 51, the bottom of segment 60 has been placed in the top of segment 70 at a junction 61, the bottom of segment 70 has been placed in the top of the segment 80 at a junction 71, the bottom of segment 80 has been placed in the top of the segment 90 at a junction 81, the bottom of segment 90 has been placed in the top of segment 100 at a junction 91, the bottom of segment 100 has been placed in the top of segment 110 at a junction 101.

In the unit 200, the segments have been oriented so that the unit 200 has been effectively bent or curved to the left. The segments of the unit 200 if FIG. 3 can be oriented so that the unit 200 is effectively bent or curved to the right, forwards or backwards, and if sufficient segments are used the unit 200 may be able to curve in a U shape or a circular shape. Typically, each segment of the unit 200 needs to maintain contact with its adjacent segments, so that no air gaps are present between adjacent segments. For example, the bottom portion 16b of segment 10 should maintain contact with the top surface (analogous to top surface 12 of segment 10) of the segment 30. If the segment 10 is rotated with respect to segment 30 too far, then the segment 10 would come out of contact with the segment 30 opening up a gap at junction 11. This is not desirable.

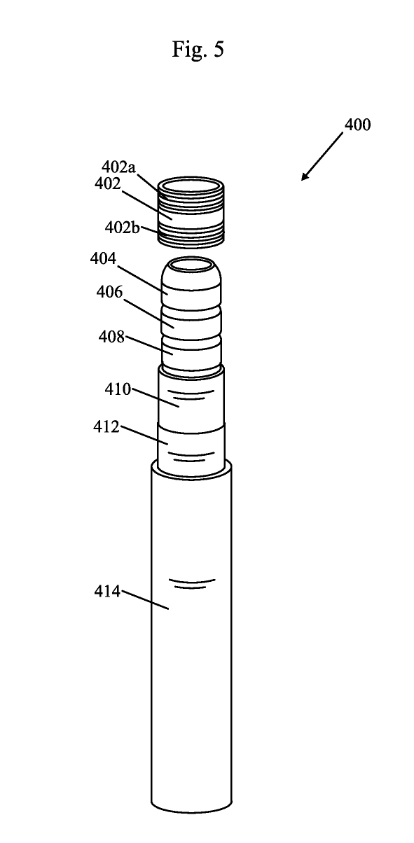

FIG. 4 shows a perspective view of the plurality of segments of FIG. 3 along with an outer housing 302, shown in dashed lines used to hold the plurality of segments together to form an apparatus 300. The outer housing 302 may be made of one or more linings as will be explained with reference to FIGS. 5-7 and may hold together the segments 10, 30, 40, 50, 60, 70, 80, 90, 100, and 110.

FIG. 5 shows a side exploded-view of an apparatus 400 in accordance with another embodiment of the present invention. The apparatus 400 includes an end connection or end connector 402 having outer threads 402a and 402b. The apparatus 400 further includes segments 404, 406, and 408 and further segments not shown in FIG. 5. Each of segments 404, 406, and 408 and further segments may be the same as segment 10 shown in FIGS. 1A-1E. Each of segments 404, 406, and 408 and further segments may be made entirely of solid ceramic. The apparatus 400 may also include an inner lining 410, a structural lining 412, and an exterior finish lining 414. Although FIG. 5 is shown so that all of the components 402, 404, 406, 408, 410, 412, and 414 can be seen, typically, in at least one embodiment, in an assembled apparatus or unit, the exterior finish lining 414 covers the structural lining 412 which covers the inner lining 410 which covers the segments 404, 406, 408, and any further segments. The outer threads 402b of the end connection or end connector 402 would be covered by the exterior finish lining 414.

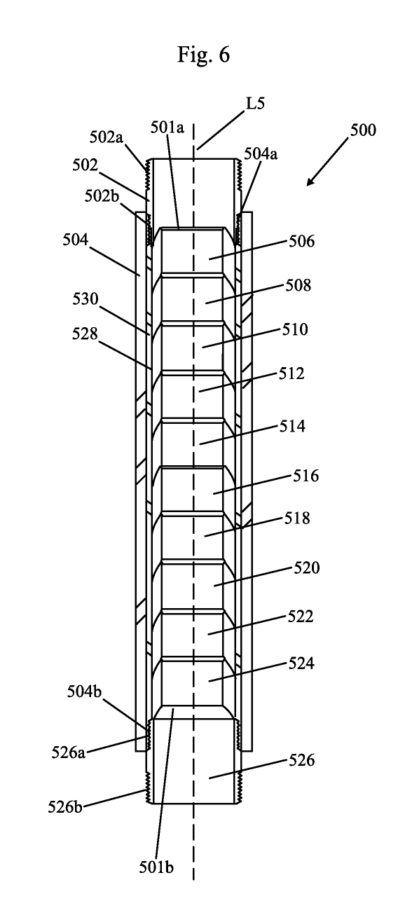

FIG. 6 shows a cross sectional view of an apparatus 500 in accordance with another embodiment of the present invention. The apparatus 500 may be a cross sectional view of an assembled version of the apparatus 400 in FIG. 5 or otherwise similar to the apparatus 400 in FIG. 5.

The apparatus 500 includes end connection or end connectors 502 and 526. The apparatus 500 further includes segments 506, 508, 510, 512, 514, 516, 518, 520, 522, and 524, each of which may be identical to segment 10 shown in FIGS. 1A-1E, and each of which may be entirely made of solid ceramic material. The apparatus 500 further includes inner lining 528 which surrounds the periphery of the segments 506, 508, 510, 512, 514, 516, 518, 520, 522, and 524 and structural lining 530 which surrounds the inner lining 528. The apparatus 500 also includes exterior finish lining 504 which surrounds structural lining 530. The inner lining 528 in surrounding the segments 506-524 may be formed into a hollow cylindrical tube with the segments 506-524 in its inner chamber or its axial bore. The structural lining 530 in surrounding the inner lining 528 may form a hollow cylindrical tube with the segments 506-524 and the inner lining 528 in its inner chamber or its axial bore. The exterior finish lining 504 in surrounding the structural lining 530 may form a hollow cylindrical tube with the segments 506-524, the inner lining 528, and the structural lining 530 in its inner chamber or axial bore.

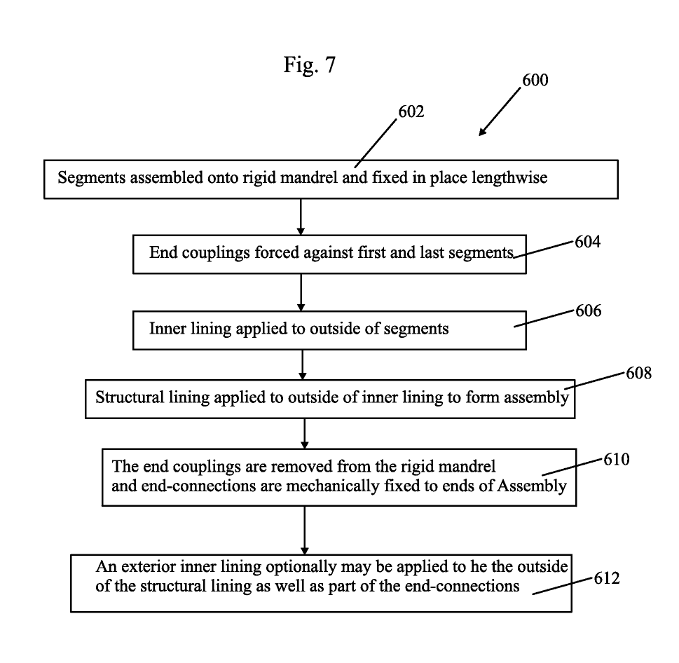

FIG. 7 shows a flow chart 600 of a method of manufacturing flexible tubing in accordance with another embodiment of the present invention. At step 602 segments, such as segments 506-524 shown in FIG. 6, are assembled onto a rigid mandrel, cylindrical axle or spindle and fixed in place lengthwise, as shown in FIG. 6 (mandrel not shown in FIG. 6). The rigid mandrel, cylindrical axle or spindle serves to keep the segments 506-524 aligned axially. The rigid mandrel is placed so that is resides in the center or bore of the segments 506-524 along line L5 as shown in FIG. 6.

End couplings, not shown, are forced against first and last segments, such as segment 506 and 524 shown in FIG. 6 at step 604. The End-couplings keep the segments 506-524 from separating while on the mandrel, and during the rest of the fabrication procedure.

At step 606, an inner lining, such as inner lining 528 in FIG. 6 or inner lining 410 in FIG. 5, is applied to outside or periphery of segments, such as segments 506-524 shown in FIG. 6. The inner lining 528 may be applied to the segments 506-524 by vulcanization, thermosetting, or air-setting. The inner lining 528 may be comprised of may consist of an elastomer, such as natural rubber, Buna-N or nitrile rubber, EPDM or ethylene propylene, a Monomer (M-class) rubber, FKM (fluoroelastomers), or any other material that can contain pressure as well be flexible.

At step 608, a structural lining, such as structural lining 530 in FIG. 6 or structural lining 412 in FIG. 5 is applied to outside of inner lining, such as 528 or 410 to form an assembly. The Structural Lining, such as 530 prevents the Inner Lining, such as 528 or 410, from deforming or delaminating off of the segments 506-524 due to fluid pressure, inside of the bores or chambers of the segments 506-524, which will be present when the finished product is installed in service. The structural lining, such as 530 or 412 may be comprised of or may consist of a series of interwoven or overlapping threads applied by hand or machine, or a wrapping of pre-made mesh or screen material. The structural lining, such as 530 or 412 material may be any type of synthetic material such as a polymer (nylon, polyester), metallic (stainless steel, carbon steel, titanium), or natural fiber (cotton, manila).

The end couplings, not shown, are then removed from the rigid mandrel and end connections or connectors 502 and 526 are mechanically fixed to ends 501a and 501b, respectively of the assembly at step 610. The End-Connections or end connectors 502 and 526 may be welded, crimped, cemented, or otherwise permanently affixed to the ends 501a and 501b of the assembly. The end connections or end connectors 502 and 526 may be any type of configuration, such as flanged, threaded, plain end, beveled, or grooved to name a few.

An exterior finish lining 504 may be optionally applied to the outside or periphery of the structural lining, such as lining 530 or 412, at step 612 of FIG. 7. The exterior finish lining, such as 504 in FIG. 6 or 414 in FIG. 5 may be any series of elastomers, similar to the inner lining 410 or 528 material, or any series of interwoven or overlapping thread/mesh material, similar to the materials used for the structural lining 412 or 530.

A complete apparatus 500 may be provided to end users of the apparatus 500 with end connections or end connectors 502 and 526 fixed on the ends 501a and 501b as shown in FIG. 6. Alternatively, an apparatus having all the components of apparatus 500 except the end connections or connectors 502 and 526 can be provided to a user, and in that case the user can crimp his or her own connectors onto ends 501a and 501b.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus for conveying fluids comprising:
a plurality of segments, including a first segment and a last segment;
an inner lining;
wherein each of the plurality of segments is substantially the same;
wherein each of the plurality of segments has a central opening, a periphery surrounding the central opening, a substantially concave top surface surrounding the central opening, and a substantially convex bottom surface surrounding the central opening;
wherein the plurality of segments are configured so that the substantially convex bottom surface of each segment of the plurality of segments, except for the last segment, sits on the substantially concave top surface of an adjacent segment of the plurality of segments;
wherein the plurality of segments are configured so that fluids can pass through the central openings of the plurality of segments;
and wherein the inner lining surrounds the periphery of each of the plurality of segments.

2. The apparatus of claim 1 wherein
each of the plurality of segments is comprised of ceramic.

3. The apparatus of claim 1 wherein
each of the plurality of segments is made entirely of ceramic.

4. The apparatus of claim 1 wherein
the inner lining is an elastomer.

5. The apparatus of claim 4 wherein
the inner lining is an elastomer selected from the group comprising natural rubber, Buna-N rubber, ethylene propylene, a monomer (M-class) rubber, and a fluoroelastomer.

6. The apparatus of claim 1 further comprising
a structural lining which surrounds the inner lining;
wherein the inner lining is an elastomer; and
and the structural lining is comprised of interwoven threads.

7. The apparatus of claim 1 wherein
each of the plurality of segments are made of a material which has been coated with wear resistant coating.

8. The apparatus of claim 1 wherein
each of the plurality of segments are made of any one of the group of cast iron, ultra-high-molecular-weight polyethylene, and glass-filled PTFE (polytetrafluoroethylene).

9. The apparatus of claim 1 wherein
the substantially concave top surface and the substantially convex bottom surface of each of the plurality of segments are aligned with and parallel to each other.
with and parallel to the corresponding substantially convex bottom surface of each of the plurality of segments,

10. The apparatus of claim 9 wherein
each of the substantially concave top surfaces and each of the substantially convex bottom surfaces has a radius of curvature of approximately sixty-four and one half degrees,

11. A method comprising the steps of
configuring a plurality of segments; and
applying an inner lining so that it surrounds a periphery of each of the plurality of segments;
wherein the plurality of segments include a first segment and a last segment;
wherein each of the plurality of segments is substantially the same;
wherein each of the plurality of segments has a central opening, a periphery surrounding the central opening, a substantially concave top surface surrounding the central opening, and a substantially convex bottom surface surrounding the central opening;
wherein the plurality of segments are configured so that the substantially convex bottom surface of each segment of the plurality of segments, except for the last segment, sits on the substantially concave top surface of an adjacent segment of the plurality of segments; and
wherein the plurality of segments are configured so that fluids can pass through the central openings of the plurality of segments.

12. The method of claim 11 wherein
the step of configuring the plurality of segments includes forcing first and second end couplings against the first and last segments respectively, applying the inner lining, and then
removing the first and second end couplings from the first and last segments.

13. The method of claim 11 wherein
the step of configuring the plurality of segments includes assembling the plurality of segments on a rigid mandrel which has been fixed in place.

14. The method of claim 12 further comprising
applying first and second end connections to the first and last segments, respectively, after removing the first and second end couplings.

15. The method of claim 11 wherein
each of the plurality of segments is comprised of ceramic.

16. The method of claim 11 wherein
each of the plurality of segments is made entirely of ceramic.

17. The method of claim 11 wherein
the inner lining is an elastomer.

18. The method of claim 17 wherein
the inner lining is an elastomer selected from the group comprising natural rubber, Buna-N rubber, ethylene propylene, a monomer (M-class) rubber, and a fluoroelastomer.

19. The method of claim 11 further comprising
applying a structural lining so that it surrounds the inner lining;
wherein the inner lining is an elastomer; and
and the structural lining is comprised of interwoven threads.

20. The method of claim 11 wherein
each of the plurality of segments are made of a material which has been coated with wear resistant coating.
